(19) United States
(12) Patent Application Publication
(10) Pub. No.: US 2012/0308983 A1
(43) Pub. Date: Dec. 6, 2012

(54) Democratic Process of Testing for Cognitively Demanding Skills and Experiences

(75) Inventor: Diya B. Obeid, New York, NY (US)

(73) Assignee: JOBDIVA, INC., New York, NY (US)

(21) Appl. No.: 13/589,161

(22) Filed: Aug. 19, 2012

Related U.S. Application Data
(62) Division of application No. 12/877,829, filed on Sep. 8, 2010.

(51) Int. Cl. G09B 7/00

(52) U.S. Cl. 434/362

(57) ABSTRACT

A system and methods for grading a candidate based on evaluations by assessors. The assessors evaluate questions that the candidate authors, and answers that the candidate prepares. Each assessor provides a question score, or answer score, as an objective measure of the evaluation. The methods retrieve a grade for each assessor, and calculate a grade for the candidate based on the question score, or answer score, and the grade for each assessor. The methods grade each assessor based on evaluations by other assessors. The other assessors evaluate the question score, or answer score, and provide an evaluation score as an objective measure of the evaluation. The methods retrieve a grade for each other assessor, and calculate a grade for the assessor based on the evaluation score, and the grade for each other assessor.

### BACKGROUND OF THE INVENTION

1. Field of the Invention

The present invention relates, in general, to the field of testing techniques. In particular, the present invention relates to testing for cognitively demanding skills and experiences.

2. Description of the Related Art

The challenge for the staffing industry is to identify individuals who are suited for cognitively demanding jobs. Recruiters, human resource generalists, career consultants, and hiring manages among others are not specialists in every skill, tool, role, or expertise for which they are hiring an experienced knowledgeable individual. Furthermore, the rate that cognitively demanding skills and experiences enter the market, as well as the rate that these skills and experiences evolve and change, make it difficult to keep their assessment tools current and up to date. In addition, most hiring managers are performing management tasks, while various skilled specialty workers are performing the cognitively demanding tasks. Thus, hiring managers are not familiar with the skills and experiences for which they are attempting to hire.

In order to assess potential candidates for these cognitively demanding jobs, employers and their consultants, such as recruiters, human resource generalists, career consultants, hiring manages, and industry specialists, traditionally develop tests, typically conducted on-line, verbally, or in writing, to evaluate each candidate's knowledge and capabilities. The prior art traditional tests for cognitively demanding skills and experiences are comprised of questions and their supposedly correct answers. The grading process for these traditional tests evaluate the answers provided by a candidate for correctness based on the alignment of the answers with the corresponding supposedly correct answers that are provided by the developers of the tests. Thus, under traditional testing, an answer can only be right or wrong, and for an answer to be correct, it must match one of the correct answers of the question. Though a question might have more than one correct answer, most questions have only one correct answer. Under traditional testing, an answer by a candidate could only be perfectly correct if it is one of the possible correct answers. Under traditional testing, when an answer receives partial credit, the partial credit reflects the correct part of the answer that is supposedly a match to a part of the correct answer. In this case, other parts of the answer are judged to be incorrect or the answer does not complete one of the correct answers. In these cases, when the answer is partially correct, the correct part of the answer is correct in no unmistakable terms. Additionally, the person who grants the credit, partial or in whole, is supposed to be an authorized examiner who is grading the answers. In the prior art, when grading a test, there could also be a reviewer who checks the validity of the examiner's judgment for as long as the examiner and the reviewer are in agreement on the assessment process and the validity of answers to each of the questions.

While valuable as an assessment and evaluation tool, these tests have many disadvantages. First, the tests rapidly age for an evolving market influenced by the introduction of new technologies, tools, and skills, becoming inapplicable to the latest versions and trends of the systems, tools, processes in which sought after employees are required to have experience. Second, the tests assume the absolute correctness or incorrectness of an answer, or a part thereof, to each of the questions. Third, the task of keeping the tests current is not only costly, but also complicated because only certain parties are acknowledged authorities and able to develop the tests or certify the correctness and validity of the tests.

Thus, the disclosed system and method for testing candidates for cognitively demanding skills and experiences is a new process that does not have these difficulties that are inherent to existing testing systems.

### SUMMARY OF THE INVENTION

Aspects of the present invention provide a system and methods for grading a candidate based on evaluations by assessors. The assessors evaluate questions that the candidate authors, and answers that the candidate prepares. Each assessor provides a question score, or answer score, as an objective measure of the evaluation. The methods retrieve a grade for each assessor, and calculate a grade for the candidate based on the question score, or answer score, and the grade for each assessor. The methods grade each assessor based on evaluations by other assessors. The other assessors evaluate the question score, or answer score, and provide an evaluation score as an objective measure of the evaluation. The methods retrieve a grade for each other assessor, and calculate a grade for the assessor based on the evaluation score, and the grade for each other assessor.

### BRIEF DESCRIPTION OF THE DRAWINGS

FIG. 1 is a flow diagram that illustrates a prior art traditional testing method performed on a client-server network system.

FIG. 2 is a network diagram that illustrates one embodiment of the hardware components of a system that performs the present invention.

FIG. 3 is a block diagram that illustrates, in detail, one embodiment of the hardware components shown in FIG. 2.

FIG. 4 is a flow diagram that illustrates methods according to various embodiments of the present invention.

FIG. 5 is a message flow diagram that illustrates methods according to various embodiments of the present invention.

FIG. 6 is a message flow diagram that illustrates methods according to various embodiments of the present invention.

### DETAILED DESCRIPTION OF THE INVENTION

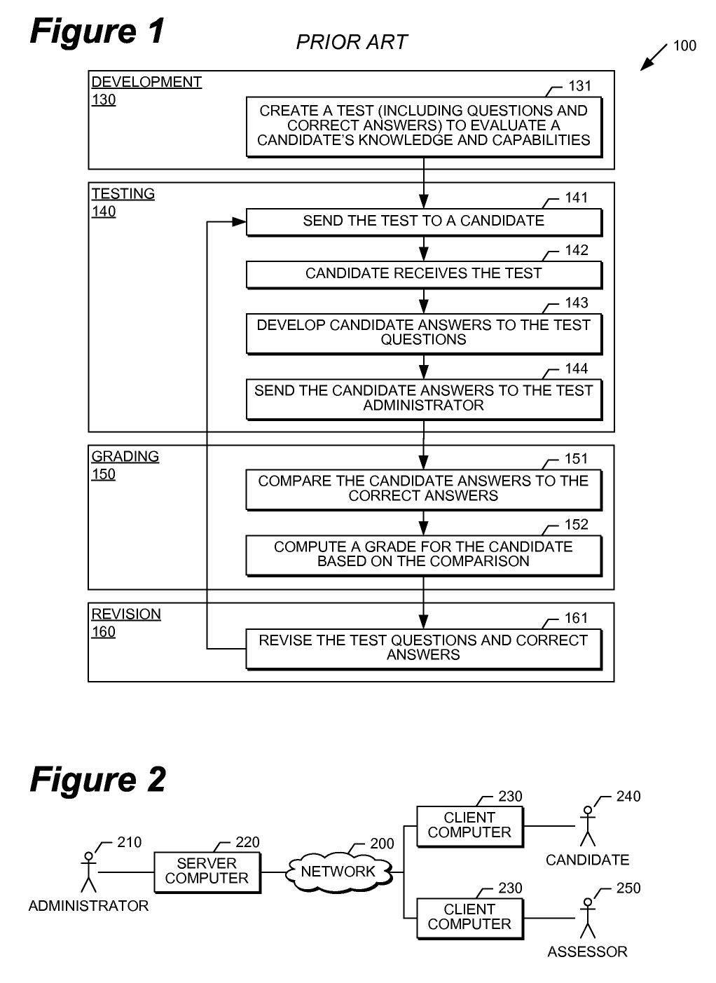

FIG. 1 is a flow diagram that illustrates a prior art traditional testing method. Today, the prior art traditional testing process 100 is typically performed on a client-server network system. As shown in FIG. 1, the prior art traditional testing process 100 is an iterative process that includes development 130, testing 140, grading 150, and revision 160 processes.

During the development 130 process, a test developer creates a test, or tests, to evaluate a candidate's knowledge of a subject and capabilities (step 131). The test includes a number of questions and correct answers that the test developer authors and certifies as correct. When the development of the test is complete, the testing 140 process begins when a test administrator sends the test to a candidate (step 141). The candidate receives the test (step 142), takes the test by developing an answer to each question (collectively, candidate answers) (step 143), and sends the candidate answers to the test administrator (step 144). The grading 150 process begins by the test administrator comparing the candidate answers to the correct answers (step 151). The test administrator computes a grade for the candidate based on the comparison (step 152). The grade is typically a percentage of the number of correct answers by the candidate. The revision 160 process begins after the grading 150 process completes, and likely after a number of iterations of the testing 140 and grading 150 processes. The revision 160 process provides the test developer the opportunity to revise the test questions and correct answers (step 161) to keep the test current and to incorporate changes and comments noted by the candidates. Revising the test is essential to ensure that the test does not diminish in value and become less applicable over time. When the revision 160 process is complete, the prior art traditional testing process 100 continues with iterations of the testing 140 and grading 150 processes.

FIG. 2 is a network diagram that illustrates one embodiment of the hardware components of a system that performs the present invention. The architecture shown in FIG. 2 utilizes a network 200 that connects a number of client computers 230 and a single server computer 220 to perform the methods of the present invention. In another embodiment, the invention distributes the processing performed by the server computer 220 among a number of server computers. In yet another embodiment, the invention distributes the processing performed by the server computer 220 among a combination of a server computer and a number of general-purpose computers. In yet another embodiment, the invention distributes the processing performed by the server computer 220 among the client computers 230 and the server computer 220.

The network 200 shown in FIG. 2, in one embodiment, is a public communication network that connects and enables data transfer between the client computers 230 and the server computer 220. The present invention also contemplates the use of comparable network architectures. Comparable network architectures include the Public Switched Telephone Network (PSTN), a public packet-switched network carrying data and voice packets, a wireless network, and a private network. A wireless network includes a cellular network (e.g., a Time Division Multiple Access (TDMA) or Code Division Multiple Access (CDMA) network), a satellite network, and a wireless Local Area Network (LAN) (e.g., Wi-Fi). A private network includes a LAN, a Personal Area Network (PAN) such as a Bluetooth network, a wireless LAN, a Virtual Private Network (VPN), an intranet, or an extranet. An intranet is a private communication network that provides an organization such as a corporation, with a secure means for trusted members of the organization to access the resources on the organization's network. In contrast, an extranet is a private communication network that provides an organization, such as a corporation, with a secure means for the organization to authorize non-members of the organization to access certain resources on the organization's network. The system also contemplates network architectures and protocols such as Ethernet, Token Ring, Systems Network Architecture, Internet Protocol, Transmission Control Protocol, User Datagram Protocol, Asynchronous Transfer Mode, and proprietary network protocols comparable to the Internet Protocol.

As shown in FIG. 2, an administrator 210 operates the server computer 220 to access the network 200 and connect to the client computers 230. The administrator 210 is responsible for coordinating the creation and maintenance of a knowledge base (i.e., a data store, or database) of questions related to a number of subjects, and the administration of tests that include a subset of the questions in the knowledge base. Similarly, a candidate 240 or an assessor 250 operate the client computer 230 to access the network 200 and connect to the server computer 220. The candidate 240 is responsible for fulfilling requests to author (i.e., develop, create, or prepare) a subset of the questions for the knowledge base, and take a test by answering other questions in the knowledge base. The assessor 250 is responsible for evaluating questions authored by the candidate 240, answers to the questions prepared by the candidate 240, and evaluations of the questions and answers by another assessor 250. In one embodiment, the assessor 250 is also a candidate 240 who is responsible for evaluating questions developed by another candidate 240.

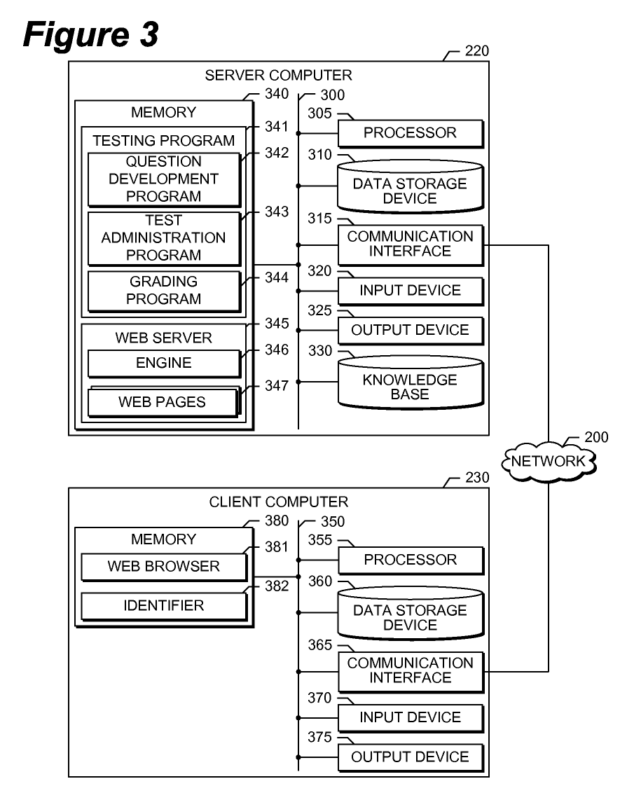

FIG. 3 is a block diagram that illustrates, in detail, one embodiment of the hardware components shown in FIG. 2. In particular, FIG. 3 illustrates, in detail, the hardware and software components that comprise the server computer 220 and the client computer 230.

The server computer 220 shown in FIG. 3 is a general-purpose computer that provides server functionality including file services, web page services, and the like. A bus 300 is a communication medium that connects a processor 305, data storage device 310, communication interface 315, input device 320, output device 325, knowledge base 330, and memory 340. The processor 305, in one embodiment, is a central processing unit (CPU). The communication interface 315 also connects to the network 200 and is the mechanism that facilitates the passage of network traffic between the server computer 220 and the network 200. FIG. 3 illustrates the data storage device 310 and the knowledge base 330 as separate components of the server computer 220; however, the present invention also contemplates incorporating the knowledge base with the data storage device 310, and incorporating the knowledge base 330 with an external device connected to the server computer 220 via the communication interface 315. In one embodiment, the knowledge base 330 is a collection of data that includes questions, where each question has a subject, is associated with a candidate 240 responsible for authoring the question, and has a number of evaluations or scores. In another embodiment, the knowledge base 330 is a collection of data that includes answers, where each answer has question on a subject, is associated with a candidate 240 responsible for preparing the answer, and has a number of evaluations or scores. In yet another embodiment, the knowledge base 330 is organized in such a way that a database management system can quickly store, modify, and extract the data from the knowledge base 330, where the database management system employs a relational, flat, hierarchical, object-oriented architecture, or the like.

The processor 305 performs the disclosed methods by executing the sequences of operational instructions that comprise each computer program resident in, or operative on, the memory 340. One skilled in the art should understand that the memory 340 also includes operating system, administrative, and database programs that support the programs disclosed in this application. In one embodiment, the configuration of the memory 340 of the server computer 220 includes a testing program 341, and web server 345. The testing program 341 includes a question development program 342, test administration program 343, and grading program 344. The web server program 345 includes an engine 346, and web pages 347. These computer programs store intermediate results in the memory 340, knowledge base 330, or data storage device 310. These programs also receive input from the administrator 210 via the input device 320, access the knowledge base 330, and display the results to the administrator 210 via the output device 325. In another embodiment, the memory 340 may swap these programs, or portions thereof, in and out of the memory 340 as needed, and thus may include fewer than all of these programs at any one time.

The engine 346 of the web server program 345 receives requests such as hypertext transfer protocol (HTTP) requests from the client computers 230 to access the web pages 347 identified by uniform resource locator (URL) addresses and provides the web pages 347 in response. The requests include a question development request that triggers the server computer 220 to execute the question development program 342, a test administration request that triggers the server computer 220 to execute the test administration program 343, and a grading request that triggers the server computer 220 to execute the grading program 344.

As shown in FIG. 3, the client computer 230 is a general-purpose computer. A bus 350 is a communication medium that connects a processor 355, data storage device 360, communication interface 365, input device 370, output device 375, and memory 380. The processor 355, in one embodiment, is a central processing unit (CPU). The communication interface 365 also connects to the network 200 and is the mechanism that facilitates the passage of network traffic between the client computer 230 and the network 200.

The processor 355 performs the disclosed methods by executing the sequences of operational instructions that comprise each computer program resident in, or operative on, the memory 380. One skilled in the art should understand that the memory 380 may include operating system, administrative, and database programs that support the programs disclosed in this application. In one embodiment, the configuration of the memory 380 of the client computer 230 includes a web browser 381 program, and an identifier 382. In one embodiment, the identifier 382 is stored in a file referred to as a cookie. The server computer 220 may assign and send the identifier 382 to the client computer 230 once when the client computer 230 first communicates with the server computer 220. From then on, the client computer 230 includes its identifier 382 with all messages sent to the server computer 220 so the server computer 220 can identify the source of the message. These computer programs store intermediate results in the memory 380, or data storage device 360. In another embodiment, the memory 380 may swap these programs, or portions thereof, in and out of the memory 380 as needed, and thus may include fewer than all of these programs at any one time.

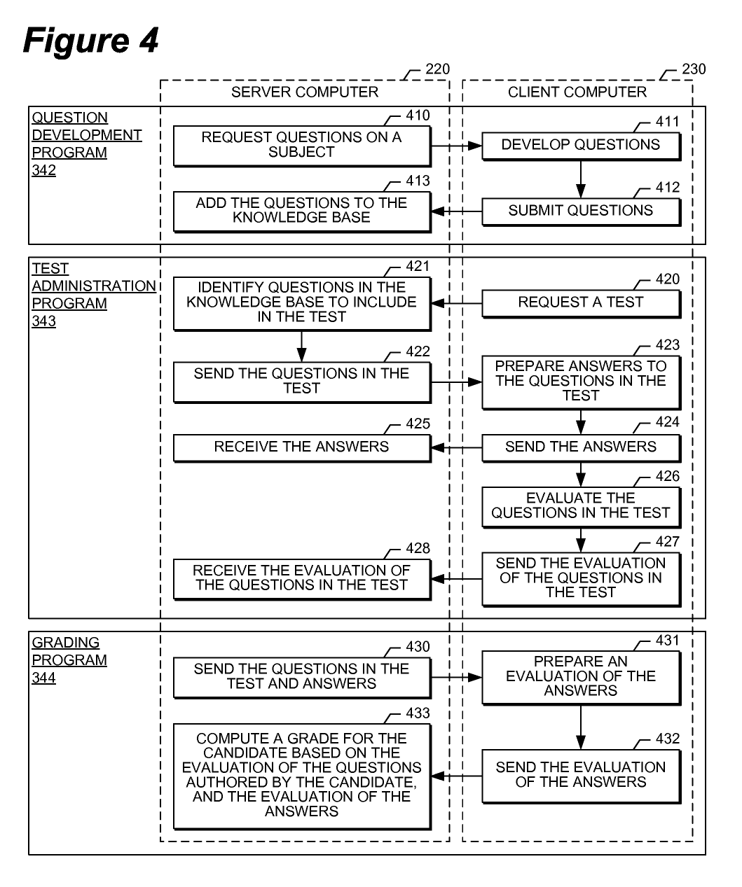

FIG. 4 is a flow diagram that illustrates methods according to various embodiments of the present invention. In particular, FIG. 4 illustrates the processes performed by the question development program 342, test administration program 343, and grading program 344 when the administrator 210 operates the server computer 220, and either the candidate 240, or assessor 250, operate the client computer 230.

The question development program 342 shown in FIG. 4 begins when the administrator 210 operates the server computer 220 to send a request for questions on a subject (step 410) to a candidate 240 operating the client computer 230. The client computer 230 receives the request and the candidate 240 authors a number of questions on the subject (step 411). The administrator 210 is requesting the questions from the candidate 240 because the candidate 240 is a proclaimed authority on the subject; however, since the administrator 210 requests questions from a variety of candidates 240, the questions that each candidate 240 develops may differ. In another embodiment, without receiving the request for the questions, the candidate 240 operates the client computer 230 to author a number of questions on a subject (step 411). When the candidate 240 has completed the development of the questions, the candidate 240 operates the client computer 230 to submit the questions to the server computer 220 (step 412). The server computer 220 receives the submitted questions and adds the questions to the knowledge base 330 (step 413). In one embodiment, the knowledge base 330 stores each question, the subject that the question addresses, and an identification of the candidate 240 responsible for developing the question.

The test administration program 343 shown in FIG. 4 begins when a candidate 240 operates the client computer 230 to send a request for a test (step 420). The server computer 220 receives the request and identifies questions in the knowledge base 330 to include in the test for the candidate 240 (step 421). In another embodiment, without receiving the request for the test, the server computer 220 identifies questions in the knowledge base 330 to include in the test for the candidate 240 (step 421). In one embodiment, the questions identified for the candidate 240 are a subset of the questions in the knowledge base 330. In another embodiment, the questions identified for the candidate 240 are a subset of the questions in the knowledge base 330, excluding any questions that the candidate 240 developed. The server computer 220 sends the questions in the test to the client computer 230 (step 422). The candidate 240 receives the questions in the test and prepares answers to the questions in the test (step 423), and sends the answers to the server computer 220 (step 424). The server computer 220 receives the answers (step 425) and stores the answers for further processing in the knowledge base 330. In one embodiment, the knowledge base 330 stores each answer, the question that the answer addresses, and an identifier associated with the candidate 240 responsible for preparing the answer.

In addition to answering the test questions, the candidate 240 serves in the role of an assessor 250 by preparing an evaluation (i.e., assessment) of the questions in the test (step 426), and sending the evaluation of the questions in the test to the server computer 220 (step 427). In one embodiment, the evaluation of each question by the assessor 250 includes determining whether the question is pertinent to the subject, and associating with each question a score that will be used to calculate a grade for the candidate 240 who developed the question. Since there is no universal evaluation of the correctness or applicability of the questions and no sanctioned authority to judge the questions, in other embodiments, the evaluation of each question by the assessor 250 may include determining the validity, soundness, correctness, suitability, applicability, or value of the question. In various embodiments, the score for each question is an objective measure of the evaluation of each question, such as a number, a percentage, a letter, a rank value, or the like. The server computer 220 receives the evaluation of the questions in the test (step 428) and stores the assessment of the test questions for further processing. In one embodiment, the server computer 220 stores the assessment of the test questions in the knowledge base 330.

The grading program 344 shown in FIG. 4 begins when the server computer 220 sends questions in the test and answers prepared by the candidate 240 to an assessor 250 (step 430). In one embodiment, the assessor 250 is a candidate 240 other than the candidate 240 who prepared the answers to the questions in the test. In another embodiment, the assessor 250 is the candidate 240 who developed the questions in the test. The client computer 230 receives the questions in the test and answers, and the assessor 250 operates the client computer 230 to prepare an evaluation of the answers (step 431). In one embodiment, the evaluation of each answer by the assessor 250 includes determining whether the answer is correct, and associating a score that will be used to calculate a grade for the candidate 240 who prepared the answers. Since there is no universal evaluation of the correctness or applicability of the answers and no sanctioned authority to judge the answers, in other embodiments, the evaluation of each answer by the assessor 250 may include determining whether the answer is correct, partially correct, or incorrect. In various embodiments, the score for each answer is an objective measure of the evaluation of each answer, such as a number, a percentage, a letter, a rank value, or the like. The assessor 250 operates the client computer 230 to send the evaluation of the answers to the server computer 220 (step 432). The server computer 220 receives the evaluation of the answers, and computes a grade for the candidate 240 based on the score for each question that the candidate 240 authored, and the score for each answer that the candidate 240 prepared to a question in the test (step 433).

In one embodiment, the grade for a candidate 240 includes two components. The first component of the grade for the candidate 240 is the evaluation of the answers prepared by the candidate 240 to questions on a test. In one embodiment, this first evaluation is the average of the evaluation for each answer by an assessor 250, multiplied by a first component factor based on the grade for the assessor 250 who provided the evaluation. For example, if a candidate 240 prepares answers to four questions on a test, which an assessor 250 evaluates as 50%, 100%, 50%, and 100%, respectively, then the average of the evaluation of the answers by the assessor 250 is 75%, and if the grade for the assessor 250 is 50%, then the grade of 75% for the candidate 240 will increase because the grade for the assessor 250 is low. The second component of the grade for the candidate 240 is the evaluation of the questions authored by the candidate 240. In one embodiment, this second evaluation is the average of the evaluation for each question by an assessor 250, multiplied by a second component factor based on the grade for the assessor 250 who provided the evaluation. For example, if a test includes four questions authored by another candidate 240, which an assessor 250 evaluates as 25%, 100%, 75%, and 100%, respectively, then the average of the evaluation of the questions is 75%, and if the grade for the assessor 250 is 100%, then the grade of 75% for the candidate 240 will not change because the grade for the assessor 250 is high.

In one embodiment, the grade for an assessor 250 also includes two components. The first component of the grade for the assessor 250 is the evaluation of the evaluations that the assessor 250 provided to answers to questions on a test. The second component of the grade for the assessor 250 is the evaluation of the evaluations that the assessor 250 provided to questions authored by a candidate 240. Both of these components are evaluations by another assessor 250 of the evaluations by the assessor 250 (i.e., re-evaluations).

One advantage of the present invention over the prior art traditional testing method is that the candidates 240 perpetuate the development of questions for the tests in the present invention. The prior art traditional testing method includes a feedback loop to allow the test developer to revise and update the test. In the present invention, the grading process inherently revises and updates the questions for the test because the questions and answers are continuously evolving. In addition, the grade for a candidate 240 also evolves as more candidates 240 join a test and as the answers to the questions converge to what would supposedly be the correct answer. The present invention defines correctness as a democratic process in which the population of candidates 240 decides which answers will prevail and which answers will not prevail. The evaluation of the answers depends on the ratio of endorsing respondents over the total respondents who received the questions and provided feedback.

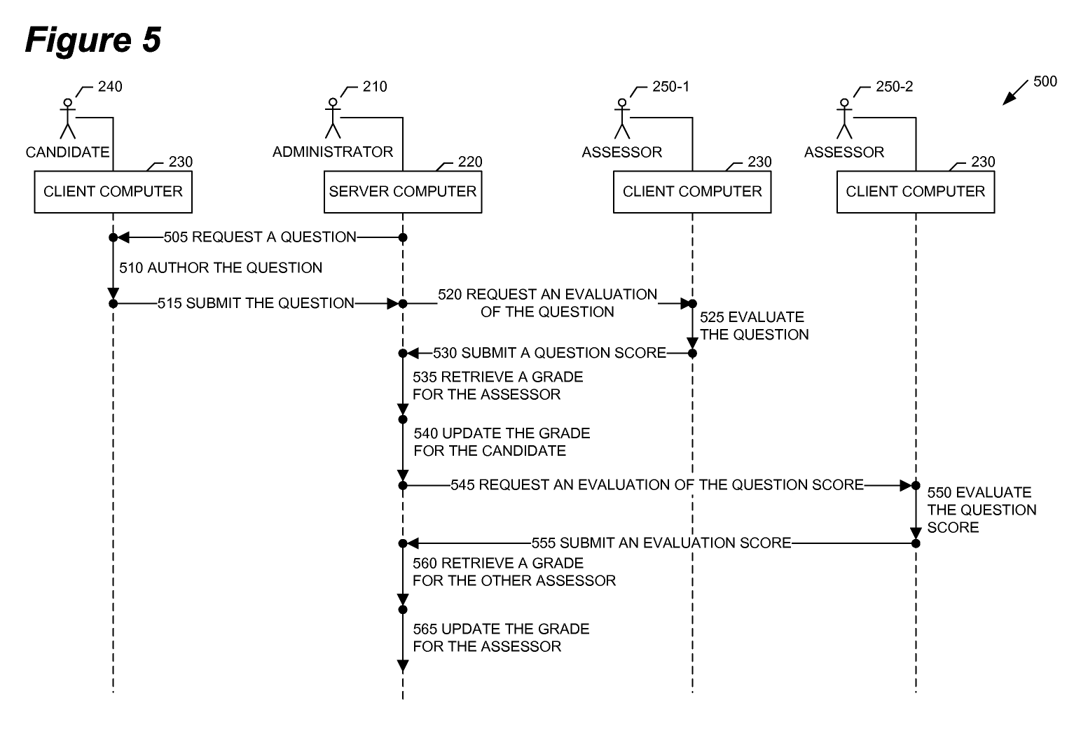

FIG. 5 is a message flow diagram that illustrates methods according to various embodiments of the present invention. In particular, FIG. 5 illustrates a process 500 for developing a question, evaluating the question, and grading the candidate 240, and assessor 250-1. An administrator 210 operates the server computer 220 to send a request to the candidate 240 to develop a question for a subject (step 505). The candidate 240 operates the client computer 230 to author the question (step 510), and submit the question in a response to the server computer 220 (step 515). The server computer 220 sends the question and the subject to an assessor 250-1 with a request for an evaluation of the question (step 520). The assessor 250-1 operates the client computer 230 to evaluate the question and the subject (step 525), and submit an objective measure of the evaluation of the question and the subject (step 530). In one embodiment, the evaluation is a determination (i.e., opinion) by the assessor 250-1 whether the question is pertinent to the subject. In another embodiment, the objective measure of the evaluation is a question score, such as a number (i.e., 1, 2, 3, etc.), percentage, letter (i.e., A, B, C, etc.), or rank value. The server computer 220 retrieves a grade for the assessor 250-1 (step 535), and updates, or calculates, the grade for the candidate 240 (step 540). The server computer 220 sends the question score, question, and subject to another assessor 250-2 with a request for an evaluation of the question score (step 545). The other assessor 250-2 operates the client computer 230 to evaluate the question score (step 550), and submit an objective measure of the evaluation of the question score (step 555). In one embodiment, the evaluation is a determination (i.e., opinion) by the other assessor 250-2 whether the question score is correct. In another embodiment, the objective measure of the evaluation is an evaluation score, such as a number (i.e., 1, 2, 3, etc.), percentage, letter (i.e., A, B, C, etc.), or rank value. The server computer 220 retrieves a grade for the other assessor 250-2 (step 560), and updates, or calculates, the grade for the assessor 250-1 (step 565). In one embodiment, the basis for the grade for the candidate 240 is at least one question score from an assessor 250-1, and the basis for the grade for the assessor 250 is at least one evaluation score from another assessor 250-2. In another embodiment, iteration of the process 500 shown in FIG. 5 develops a number of question scores for the candidate 240 that the server computer 220 uses to calculate a grade for the candidate 240, and a number of evaluation scores for the assessor 250-1 that the server computer 220 uses to calculate a grade for the assessor 250-1. In one embodiment, the grade for the candidate 240 includes a combination of the question scores in a mathematical function such as an average, median, or standard deviation, and the grade for the assessor 250-1 includes a combination of the evaluation scores in a mathematical function such as an average, median, or standard deviation.

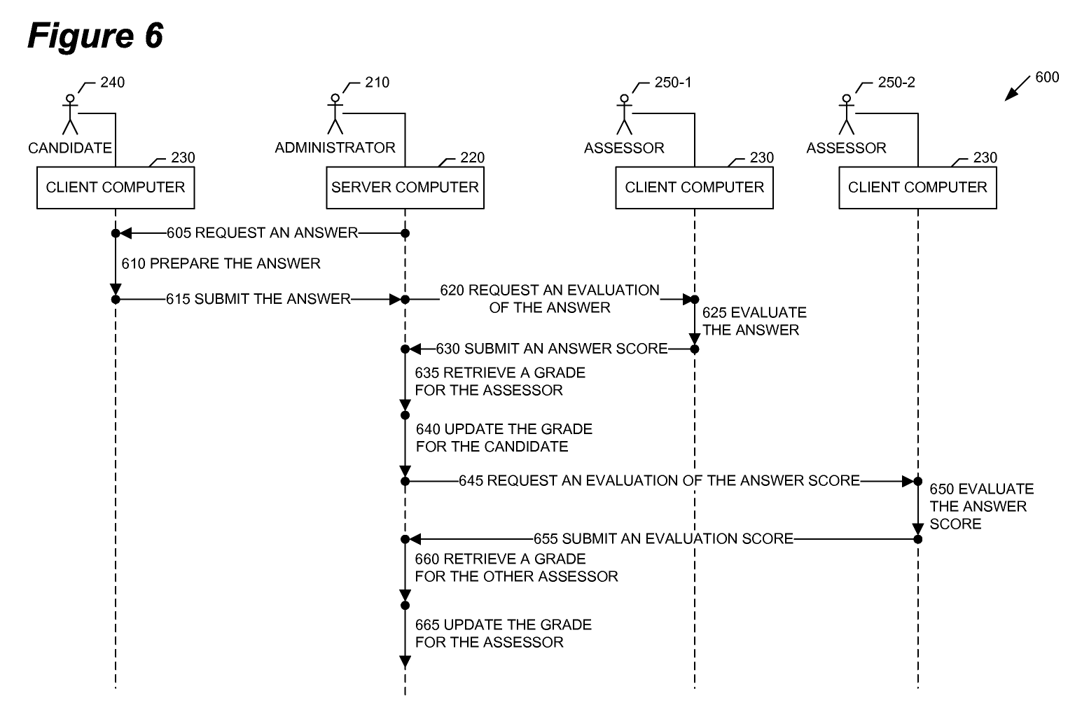

FIG. 6 is a message flow diagram that illustrates methods according to various embodiments of the present invention. In particular, FIG. 6 illustrates a process 600 for preparing an answer to a question, evaluating the answer, and grading the candidate 240, and assessor 250-1. An administrator 210 operates the server computer 220 to send a request to the candidate 240 to prepare an answer to a question on a test (step 605). The candidate 240 operates the client computer 230 to prepare the answer (step 610), and submit the answer in a response to the server computer 220 (step 615). The server computer 220 sends the answer and the question to an assessor 250-1 with a request for an evaluation of the answer (step 620). The assessor 250-1 operates the client computer 230 to evaluate the answer and the question (step 625), and submit an objective measure of the evaluation of the answer and the question (step 630). In one embodiment, the evaluation is a determination (i.e., opinion) by the assessor 250-1 whether the answer is correct. In another embodiment, the objective measure of the evaluation is an answer score, such as a number (i.e., 1, 2, 3, etc.), percentage, letter (i.e., A, B, C, etc.), or rank value. The server computer 220 retrieves a grade for the assessor 250-1 (step 635), and updates, or calculates, the grade for the candidate 240 (step 640). The server computer 220 sends the answer score, answer, and question to another assessor 250-2 with a request for an evaluation of the answer score (step 645). The other assessor 250-2 operates the client computer 230 to evaluate the answer score (step 650), and submit an objective measure of the evaluation of the answer score (step 655). In one embodiment, the evaluation is a determination (i.e., opinion) by the other assessor 250-2 whether the answer score is correct. In another embodiment, the objective measure of the evaluation is an evaluation score, such as a number (i.e., 1, 2, 3, etc.), percentage, letter (i.e., A, B, C, etc.), or rank value. The server computer 220 retrieves a grade for the other assessor 250-2 (step 660), and updates, or calculates, the grade for the assessor 250-1 (step 665). In one embodiment, the basis for the grade for the candidate 240 is at least one answer score from an assessor 250-1, and the basis for the grade for the assessor 250 is at least one evaluation score from another assessor 250-2. In another embodiment, iteration of the process 600 shown in FIG. 6 develops a number of answer scores for the candidate 240 that the server computer 220 uses to calculate a grade for the candidate 240, and a number of evaluation scores for the assessor 250-1 that the server computer 220 uses to calculate a grade for the assessor 250-1. In one embodiment, the grade for the candidate 240 includes a combination of the answer scores in a mathematical function such as an average, median, or standard deviation, and the grade for the assessor 250-1 includes a combination of the evaluation scores in a mathematical function such as an average, median, or standard deviation.

Although the disclosed embodiments describe a fully functioning method of testing for cognitively demanding skills and experiences, the reader should understand that other equivalent embodiments exist. Since numerous modifications and variations will occur to those reviewing this disclosure, this democratic process and method of testing for cognitively demanding skills and experiences is not limited to the exact construction and operation illustrated and disclosed. Accordingly, this disclosure intends all suitable modifications and equivalents to fall within the scope of the claims.

1-31. (canceled)

32. A method implemented in a computer, comprising:
requesting that a candidate prepare an answer to a question based on a subject;
receiving the answer from the candidate;
requesting an evaluation of the answer and the question from at least one assessor;
receiving an answer score from each assessor, wherein the answer score is an objective measure of the evaluation of the answer and the question;
receiving a grade for each assessor; and
calculating a grade for the candidate based on the answer score from each assessor, and the grade for each assessor.

33. The method of claim 32, wherein a purpose of the question is to determine a level of skill or experience that a test taker has in the subject.

34. The method of claim 32, wherein the receiving of the answer further comprises:
storing the answer;
storing the question; and
associating the candidate, the answer, and the question.

35. The method of claim 32, wherein the evaluation of the answer and the question includes said at least one assessor determining whether the answer is a correct answer to the question.

36. The method of claim 32, wherein the receiving of the answer score further comprises:
storing the answer score; and
associating the assessor, the answer, and the answer score.

37. The method of claim 32, wherein the answer score is at least one of a number, a percentage, a letter, and a rank value.

38. The method of claim 32, wherein the grade for each assessor is at least one of a number, a letter, and a rank value.

39. The method of claim 32, wherein the grade for each assessor is based on at least one evaluation by at least one other assessor of at least one other answer score from the assessor.

40. The method of claim 32 wherein the grade for the candidate is at least one of a number, a letter, and a rank value.

41. The method of claim 32, further comprising:
requesting an evaluation of the answer score from at least one other assessor; and
receiving an evaluation score from each other assessor, wherein the evaluation score is an objective measure of the evaluation of the answer score; and
calculating the grade for each assessor based on the evaluation score from each other assessor.

42. The method of claim 41, wherein the evaluation of the answer score includes said at least one other assessor determining whether the answer score is accurate.

43. The method of claim 41, wherein the receiving of the evaluation score further comprises:
storing the evaluation score; and
associating the other assessor, the assessor, and the evaluation score.

44. The method of claim 41, wherein the evaluation score is at least one of a number, a letter, and a rank value.

45. The method of claim 32, wherein the candidate is an assessor.

46. The method of claim 32, wherein the assessor is a candidate.

47. A system, comprising:
a memory device resident in a computer; and
a processor disposed in communication with the memory device, the processor configured to:
request that a candidate prepare an answer to a question based on a subject;
receive the answer from the candidate;
request an evaluation of the answer and the question from at least one assessor;
receive an answer score from each assessor, wherein the answer score is an objective measure of the evaluation of the answer and the question;
receive a grade for each assessor; and
calculate a grade for the candidate based on the answer score from each assessor, and the grade for each assessor.

48. The system of claim 47, wherein a purpose of the question is to determine a level of skill or experience that a test taker has in the subject.

49. The system of claim 47, wherein to receive the answer, the processor is further configured to:
store the answer;
store the question; and
associate the candidate, the answer, and the question.

50. The system of claim 47, wherein the evaluation of the answer and the question includes said at least one assessor determining whether the answer is a correct answer to the question.

51. The system of claim 47, wherein to receive the answer score, the processor is further configured to:
store the answer score; and
associate the assessor, the answer, and the answer score.

52. The system of claim 47, wherein the answer score is at least one of a number, a percentage, a letter, and a rank value.

53. The system of claim 47, wherein the grade for each assessor is at least one of a number, a letter, and a rank value.

54. The system of claim 47, wherein the grade for each assessor is based on at least one evaluation by at least one other assessor of at least one other answer score from the assessor.

55. The system of claim 47, wherein the grade for the candidate is at least one of a number, a letter, and a rank value.

56. The system of claim 47, wherein the processor is further configured to:
request an evaluation of the answer score from at least one other assessor; and
receive an evaluation score from each other assessor, wherein the evaluation score is an objective measure of the evaluation of the answer score; and
calculate the grade for each assessor based on the evaluation score from each other assessor.

57. The system of claim 56, wherein the evaluation of the answer score includes said at least one other assessor determining whether the answer score is accurate.

58. The system of claim 56, wherein to receive the evaluation score, the processor is further configured to:
store the evaluation score; and
associate the other assessor, the assessor, and the evaluation score.

59. The system of claim 56, wherein the evaluation score is at least one of a number, a letter, and a rank value.

60. The system of claim 47, wherein the candidate is an assessor.

61. The system of claim 47, wherein the assessor is a candidate.

62. A non-transitory computer-readable storage medium, comprising computer-executable instructions that, when executed on a computing device, perform steps of:
requesting that a candidate prepare an answer to a question based on a subject;
receiving the answer from the candidate;
requesting an evaluation of the answer and the question from at least one assessor;
receiving an answer score from each assessor, wherein the answer score is an objective measure of the evaluation of the answer and the question;
receiving a grade for each assessor; and
calculating a grade for the candidate based on the answer score from each assessor, and the grade for each assessor.
